(19) United States
(12) Patent Application Publication
(10) Pub. No.: US 2026/0084449 A1
(43) Pub. Date: Mar. 26, 2026

(54) PRINTER APPARATUS

(71) Applicant: TOSHIBA TEC KABUSHIKI KAISHA, Tokyo (JP)

(72) Inventors: Tsuyoshi Sanada, Susono Shizuoka (JP); Kenji Eoka, Sunto Shizuoka (JP); Yuji Kawamorita, Mishima Shizuoka (JP); Tsuyoshi Shimada, Mishima Shizuoka (JP)

(21) Appl. No.: 19/246,803

(22) Filed: Jun. 24, 2025

(30) Foreign Application Priority Data
Sep. 25, 2024 (JP) 2024-165981

(51) Int. Cl. B41J 13/10; B41J 3/407; B41J 11/00; B41J 11/70; B41J 13/22

(52) U.S. Cl. CPC B41J 13/106; B41J 3/407; B41J 11/006; B41J 11/70; B41J 13/22

(57) ABSTRACT

A printer apparatus includes: a printing portion configured to perform printing while pulling out and conveying strip-shaped paper from roll paper wounded the paper with a first surface facing outward; a cutting portion provided downstream of the printing portion in a paper conveying direction to cut the paper; a support portion provided downstream of the cutting portion in the paper conveying direction to come into contact with a second surface that is a back surface of the first surface to support the paper, the support portion having a pair of recesses located apart from each other in a paper width direction and a protrusion located between the pair of recesses; and a holding portion provided downstream of the cutting portion in the paper conveying direction at a position where the holding portion faces the pair of recesses and presses the first surface of the paper supported by the support portion.

### CROSS-REFERENCE TO RELATED APPLICATION

This application is based upon and claims the benefit of priority from Japanese Patent Application No. 2024-165981, filed on Sep. 25, 2024, the entire contents of which are incorporated herein by reference.

### FIELD

Embodiments described herein relate generally to a printer apparatus, methods for a printer, and a thermal printer.

### BACKGROUND

In related art, there is a printer apparatus that pulls out paper from roll paper and performs printing output. Such a printer apparatus is used, for example, for printing and issuing receipts. The receipt is cut each time the receipt is issued. In order to make it less likely for the receipt to fall from a paper discharge port, the printer apparatus includes a support portion that supports the cut receipt from below and a member for holding the paper onto the support portion. The member typically has a brush shape, and tips of bristles constituting the brush slide on an upper surface of the discharged paper.

Since the brush-shaped member as described above wears out at the tips of the bristles due to sliding on the paper, the member is a consumable and thus: requires regular replacement (maintenance).

### DESCRIPTION OF THE DRAWINGS

FIG. 1 is a perspective view showing an example of appearance of a printer apparatus according to an embodiment.

FIG. 2 is a perspective view showing the printer apparatus in a state in which a housing is opened.

FIG. 3 is a cross-sectional view showing an example of an internal structure of the printer apparatus.

FIG. 4 is a cross-sectional view showing the printer apparatus in the state in which the housing is opened.

FIG. 5 is an enlarged cross-sectional view of a portion around a paper discharge port.

FIG. 6 is an enlarged cross-sectional view of the portion around the paper discharge port.

FIG. 7 is a schematic view showing an operation of a swing portion.

FIG. 8 is a partial cross-sectional view schematically showing a positional relationship between the swing portion and a periphery thereof from a rear side.

FIG. 9 is an enlarged cross-sectional view of the portion around the paper discharge port.

### DETAILED DESCRIPTION

A problem to be solved by the disclosure is to provide a printer apparatus that makes it less likely for cut and discharged paper to fall by a structure that can be formed by a wear-resistant component.

In general, according to one embodiment, a printer apparatus includes: a printing portion configured to perform printing while pulling out and conveying strip-shaped paper from roll paper wounded the paper with a first surface facing outward; a cutting portion provided downstream of the printing portion in a paper conveying direction and configured to cut the paper; a support portion provided downstream of the cutting portion in the paper conveying direction and configured to come into contact with a second surface that is a back surface of the first surface to support the paper, the support portion having a pair of recesses located apart from each other in a paper width direction and a protrusion located between the pair of recesses; and a holding portion provided downstream of the cutting portion in the paper conveying direction at a position where the holding portion faces the pair of recesses and is configured to press the first surface of the paper supported by the support portion.

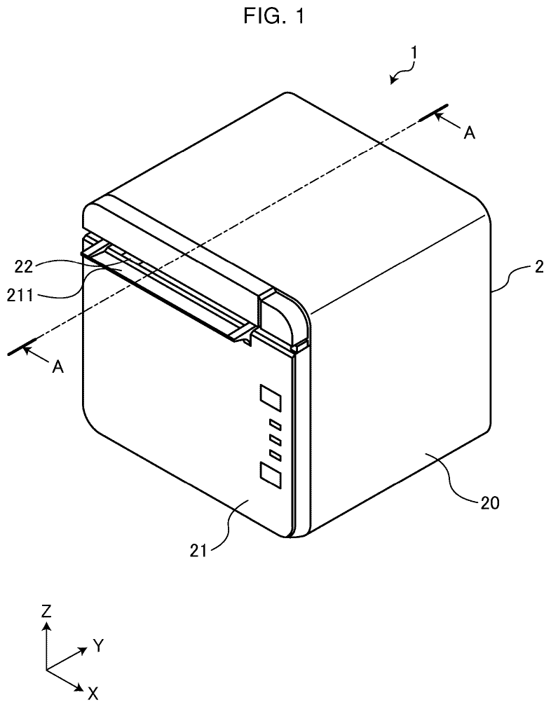

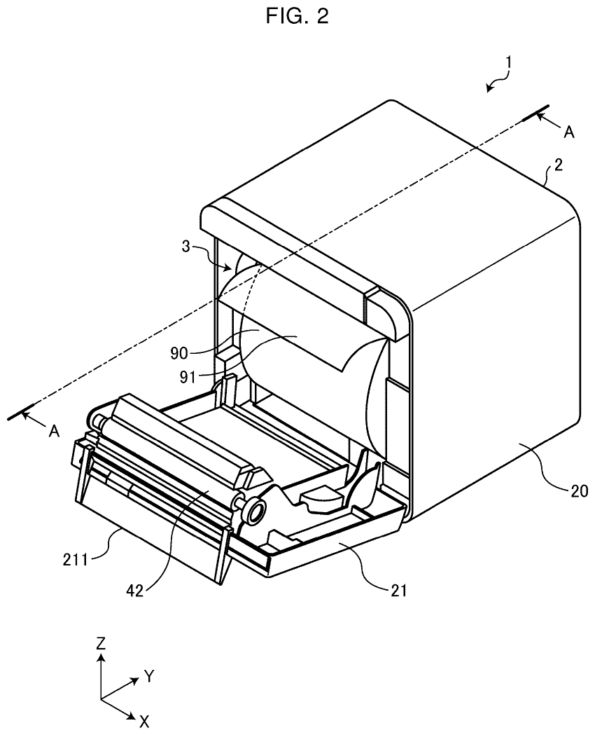

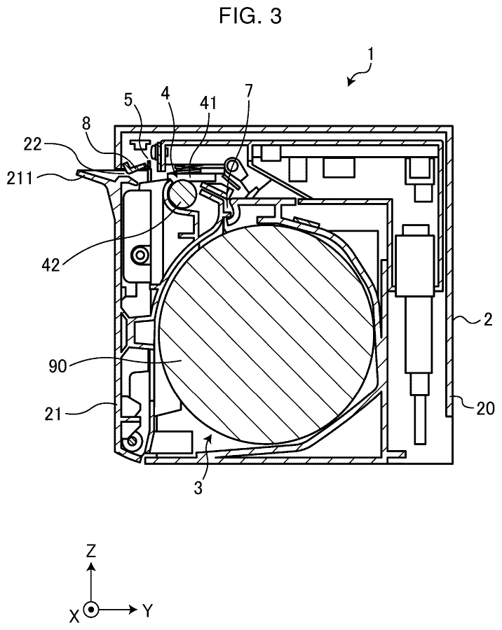

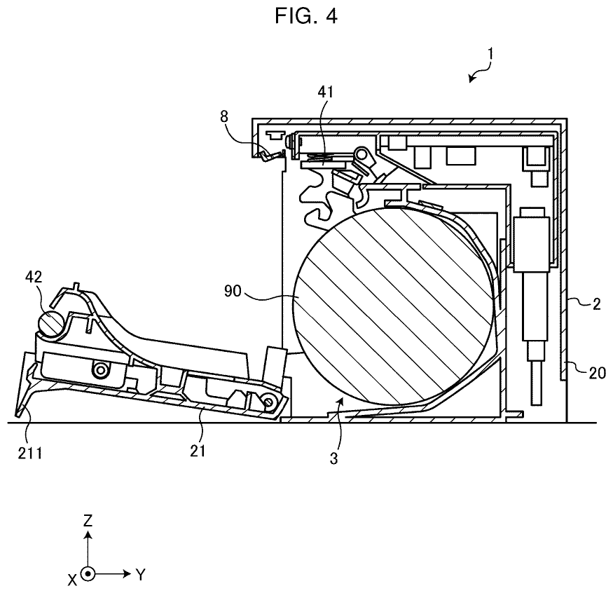

The embodiment will be described with reference to the drawings. FIG. 1 is a perspective view showing an example of appearance of a printer apparatus 1 according to the embodiment. FIG. 2 is a perspective view showing the printer apparatus 1 in a state in which a housing 2 is opened. FIG. 3 is a cross-sectional view showing an example of an internal structure of the printer apparatus 1. FIG. 4 is a cross-sectional view showing the printer apparatus 1 in the state in which the housing 2 is opened. FIGS. 3 and 4 are cross-sectional views of the printer apparatus 1 taken along the lines A-A in FIGS. 1 and 2.

The printer apparatus 1 includes the housing 2, a paper storage portion 3, a printing portion 4, a cutting portion 5, a buffer portion 7, and a swing portion 8. In the drawings, an X-axis direction indicates a width direction (left-right direction) of the printer apparatus 1, a Y-axis direction indicates a depth direction (front-rear direction) of the printer apparatus 1, and a Z-axis direction indicates a height direction (up-down direction) of the printer apparatus 1. A positive direction of the Z-axis is upward from a bottom of the printer apparatus 1. A positive direction of the Y-axis is a direction from a front side to a rear side of the printer apparatus 1. A positive direction of the X-axis is a direction from left to right when the printer apparatus 1 is viewed in the positive direction of the Y-axis.

The printer apparatus 1 according to the embodiment is a thermal printer and is used as a receipt printer for printing (printing, outputting, issuing) receipts, for example.

The housing 2 houses other portions (the paper storage portion 3, the printing portion 4, the cutting portion 5, the buffer portion 7, the swing portion 8, and the like). The housing 2 is box-shaped and has a lid 21 for opening and closing a main body 20 on a front surface. As shown in FIG. 3, the lid 21 in the embodiment has a lower side portion pivotably supported by an edge of an opening of the main body 20, and opens and closes the opening of the main body 20 according to pivoting. In a state in which the lid 21 closes the main body 20, as shown in FIG. 1, a paper discharge port 22 is formed between an upper side of the lid 21 and the edge of the opening of the main body 20. The paper discharge port 22 is an opening for discharging paper 91 from the housing 2.

The lid 21 of the printer apparatus 1 has a support portion 211 at an upper side portion. The support portion 211 is provided downstream of the cutting portion 5 in a paper conveying direction and has an inclined surface that comes into contact with a back surface of a printed surface of the paper 91 to support the paper 91. The inclined surface displaces a leading end portion of the paper 91, which moves along with conveyance, in a direction from the back surface of the paper 91 toward the printed surface.

More specifically, the support portion 211 is located outside the paper discharge port 22 and supports a lower side of the paper 91 discharged from the paper discharge port 22. The support portion 211 is detachably attached to the paper discharge port 22 or is provided integrally with the paper discharge port 22. That is, the support portion 211 is detachably attached at the lid 21 or integrally formed with the lid 21. The support portion 211 may be referred to as a table.

The paper storage portion 3 stores roll paper 90 such that the paper 91 can be pulled out from the roll paper 90. The roll paper 90 is wounded the strip-shaped paper 91 with a first surface facing outward. The first surface in the embodiment is a surface where printing is performed (that is, the printed surface). Therefore, an outer peripheral surface of the roll paper 90 is the printed surface of the paper 91. The back surface of the printed surface is an example of a second surface. The paper 91 is an example of a sheet-shaped printing medium. In a state in which the lid 21 is located at a position where the main body 20 is opened, the paper storage portion 3 is opened and the roll paper 90 can be replaced or added.

The printer apparatus 1 performs printing on the paper 91 while pulling out and conveying the paper 91 from the roll paper 90 stored in the paper storage portion 3.

The buffer portion 7 functions as a so-called damper and absorbs tension applied to the paper 91 until the roll paper 90 starts to rotate stably as the paper 91 starts to be conveyed. Accordingly, the buffer portion 7 stabilizes printing of the printing portion 4.

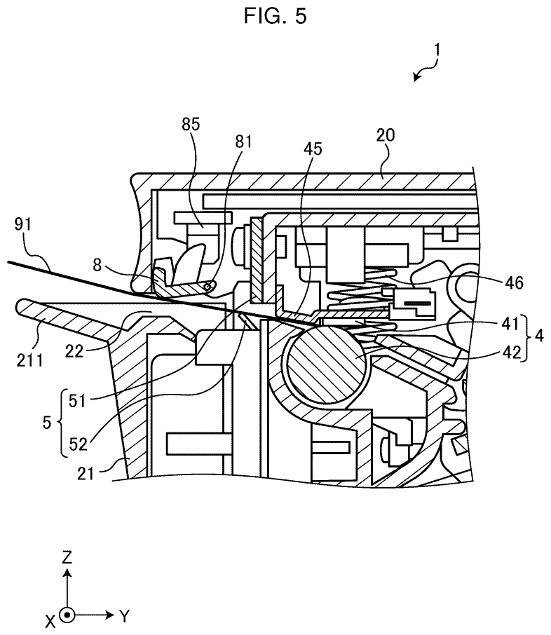

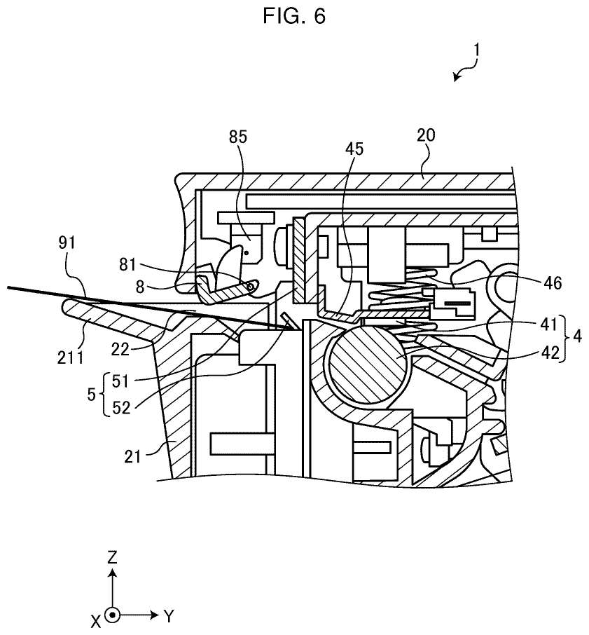

Here, FIGS. 5 and 6 are enlarged cross-sectional views showing a portion around the paper discharge port 22, FIG. 5 shows a state before cutting the paper 91, and FIG. 6 shows a state after cutting the paper 91.

The printing portion 4 performs printing on the paper 91 while pulling out and conveying the paper 91 from the roll paper 90 wounded the strip-shaped paper 91, and includes a print head 41 and a platen 42. The print head 41 is provided at the main body 20, and the platen 42 is provided at the lid 21. The platen 42 in the embodiment is a roller and is rotationally driven to convey the paper 91 interposed between the platen 42 and the print head 41.

The print head 41 is a thermal head having a structure in which a plurality of heat-generating elements are aligned. The print head 41 performs printing on the paper 91 interposed between the platen 42 and the print head 41 by causing a heat-generating element corresponding to a printing pattern to generate heat.

More specifically, the print head 41 is attached to the support portion 45, and the print head 41 is disposed at a position facing the platen 42. The support portion 45 is biased by an elastic force of a spring 46 in a direction in which the print head 41 is pressed against the platen 42. Accordingly, the print head 41 is biased in a direction in which the print head 41 is pressed against the platen 42.

When replenishing or replacing the roll paper 90, a user opens the lid 21, replenishes or replaces the roll paper 90, interposes the leading end portion of the paper 91 pulled out from the roll paper 90 between the platen 42 and the print head 41, and closes the lid 21. Accordingly, the leading end portion of the paper 91 is held by the platen 42 and the print head 41.

The cutting portion 5 is provided downstream of the printing portion 4 in the paper conveying direction, is configured to cut the paper 91, and includes a fixed blade 51 and a movable blade 52. The movable blade 52 is a blade movable in a thickness direction of the paper 91. A moving mechanism for moving the movable blade 52 moves the movable blade 52 in the up-down direction (Z-axis direction) in the drawing under the control of a control unit mounted in the printer apparatus 1. The fixed blade 51 is provided at a position facing the movable blade 52 at a fixed position in the main body 20.

When printing on the paper 91 is completed, the movable blade 52 moves from a back side of the paper 91 to a front side of the paper 91, and the paper 91 is interposed between the moved movable blade 52 and the fixed blade 51, whereby the paper 91 is cut. The front side of the paper 91 corresponds to, for example, the printed surface of the paper 91. The back side of the paper 91 corresponds to a side opposite to the printed surface (non-printed surface) of the paper 91.

Use of the cutting portion 5 is not limited to cutting (full cutting) the paper 91. For example, the cutting portion 5 can also execute partial cutting for cutting a part of the paper 91. The full cutting and the partial cutting are set in advance via an operation portion (not shown) according to an instruction of the user.

The swing portion 8 is an example of a holding portion. The holding portion is provided at a position downstream of the cutting portion 5 in the paper conveying direction and upstream of the paper discharge port 22, and holds the first surface (printed surface) of the paper 91 supported by the support portion 211.

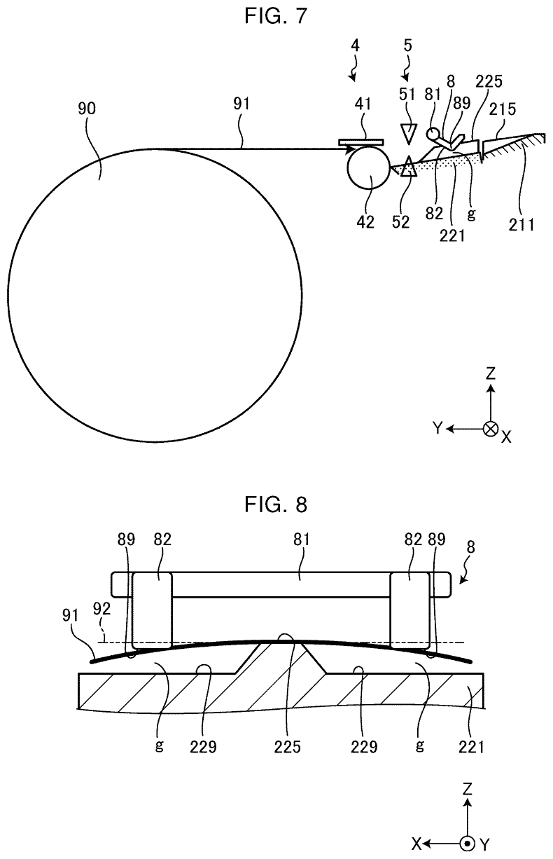

FIG. 7 is a schematic view showing an operation of the swing portion 8. FIG. 8 is a partial cross-sectional view schematically showing the positional relationship between the swing portion 8 and the periphery thereof from a rear side. The swing portion 8 includes a shaft 81, a pair of guide surfaces 82, a pair of pressing portions 89, and the like.

The shaft 81 is the center of swinging of the swing portion 8, and a longitudinal direction (axial direction) thereof is oriented in a width direction of the paper 91. The swing portion 8 is pivotable (swingable) around the shaft 81. The swing portion 8 may be referred to as a flapper.

The pressing portion 89 has a shape bent in a valley fold along a crease line parallel to the shaft 81. The pressing portion 89 is located downstream of the shaft 81 in the paper conveying direction. The pressing portion 89 is a lower end portion of the swing portion 8. That is, the pressing portion 89 is a lowest portion of the swing portion 8. The pressing portion 89 is located at a portion away from the shaft 81 (for example, in the vicinity of an opposite side of the shaft 81 when the shaft 81 is provided on one side of the swing portion 8), and moves significantly along with pivoting around the shaft 81.

The guide surface 82 is at least a part of a surface of the swing portion 8 facing the paper 91 (lower surface) and is located upstream of the pressing portion 89 in the paper conveying direction. The guide surface 82 is a portion with which the leading end and the printed surface of the conveyed paper 91 come into contact, defines a traveling direction of the paper 91, and guides the paper 91 in a predetermined direction. As the conveyance of the paper 91 progresses, the leading end of the paper 91 moves downstream in the paper conveying direction along the guide surface 82. The guide surface 82 in the embodiment is inclined such that the paper 91 is directed downward toward a downstream side in the conveying direction. The guide surface 82 may not be flat and may be, for example, a curved surface.

Such a swing portion 8 holds (presses) the first surface of the paper 91 due to an action of own weight thereof. A force pushing up the swing portion 8 against such a pressing force is hereinafter referred to as a push-up force. When the push-up force exceeds the pressing force, the swing portion 8 swings by pivoting around the shaft 81.

Here, the printer apparatus 1 includes a sensor 85 that detects the swing portion 8 swinging more than a predetermined level. When the paper 91 is jammed in the vicinity of the paper discharge port 22 and a jam occurs, the swing portion 8 swings significantly and a movement amount (or a pivoting angle) thereof exceeds the predetermined level. When the sensor 85 provided in the printer apparatus 1 detects the swing portion 8 that swings significantly beyond the predetermined degree, the control unit of the printer apparatus 1 determines that a jam has occurred. The control unit includes a central processing unit (CPU), a read only memory (ROM), a random access memory (RAM), and the like, and implements a predetermined functional unit by the CPU loading a program stored in the ROM or the like into the RAM and executing the program.

It is appropriate that the pressing force by the swing portion 8 is sufficiently larger than the push-up force due to stiffness of about a single sheet of the paper 91, and does not exceed the push-up force when the jam occurs.

The swing portion 8 also serves a role by providing another function in addition to the function for jam detection. The other function is to hold the cut paper 91 on the support portion 211 (paper holding function).

Here, the printer apparatus 1 includes a support portion 221. The support portion 221 is located inside the paper discharge port 22 and supports the paper 91 from below in a section from downstream of the printing portion 4 to immediately before the paper discharge port 22 via the cutting portion 5. After the support portion 221, the support portion 211 supports the lower surface of the paper 91 behind the paper discharge port 22. The support portion 221 and the support portion 211 in the example shown in FIG. 7 are substantially flat surfaces, and an angle formed therebetween is an obtuse angle.

A position of the swing portion 8 shown in FIG. 7 is an initial position. In order to support the paper 91 between the swing portion 8 and the support portion 211, desired positions and operations are set. As the paper 91 is discharged, the paper 91 and the swing portion 8 interfere with each other. When the push-up force of the paper 91 exceeds the pressing force of the swing portion 8, the swing portion 8 moves (swings) from the initial position.

The swing portion 8 holds a rear end of the cut paper 91 on the downstream side in the conveying direction between the swing portion 8 and an upper surface (inclined surface) of the support portion 211 to prevent the paper 91 from falling from the paper discharge port 22. The swing portion 8 does not need to be pressed against the support portion 211 to hold the paper 91, and faces the support portion 211 with a predetermined gap g between the support portion 211 and the lower end portion (pressing portion 89).

Since the paper 91 is curved according to a diameter of the roll paper 90 and has stiffness according to a thickness or the like, in a state in which the paper 91 is cut and placed on the support portion 221 and the support portion 211, a center portion in a length direction is separated from the upper surface of the support portion 211 and maintains the curved state. When the swing portion 8 operates to hold the paper 91 in a direction in which the curve is weakened and approaches the upper surface of the support portion 211, the paper 91 receives the pressing force of the swing portion 8 and the swing portion 8 receives the push-up force due to the stiffness of about a single sheet of the paper 91. Accordingly, the paper 91 is held between the swing portion 8 and the support portion 211.

With such a shape and arrangement of the swing portion 8, the leading end of the paper 91 is guided by the guide surface 82 and reaches the gap g between the pressing portion 89 and the support portion 221. Then, the paper 91 passes through the gap g between the pressing portion 89 and the support portion 221, exits from the paper discharge port 22 and reaches the support portion 211.

The support portion 211 is inclined to be located higher toward the downstream side in the paper conveying direction in order to make it less likely for the paper 91 having a length hanging down beyond a tip of the support portion 211 to fall. The upper surface of the support portion 211 and an upper surface of the support portion 221 form an obtuse angle.

As shown in FIG. 8, the support portion 211 has a protrusion 225 and a pair of recesses 229 at the upper surface. The pair of recesses 229 are located apart from each other in the paper width direction. The protrusion 225 is a portion protruding upward from the periphery thereof (recesses 229) and is located between the pair of recesses 229.

The protruding height of the protrusion 225 from the periphery thereof gradually decreases (lowers) from upstream to downstream in the paper conveying direction. Each of the pair of recesses 229 faces the corresponding pressing portion 89 via the gap g.

The pair of recesses 229 are located apart from each other in the paper width direction with the protrusion 225 interposed therebetween. The protrusion 225 is located between the pair of recesses 229.

The pair of pressing portions 89 in the embodiment are located on both sides in the width direction (paper width direction) of the paper 91, and the protrusion 225 is located at the center in the paper width direction. However, this embodiment is an example, and implementation is not limited thereto.

An imaginary line 92 indicated by a two-dot dashed line in FIG. 8 indicates the paper 91 before being guided by the guide surface 82 of the swing portion 8. In the embodiment, the imaginary line 92 is used as a reference for setting the initial position of the swing portion 8. The imaginary line 92 is a line in contact with a tip of the protrusion 225.

The pressing portion 89 located at an initial position interferes with (intersects) the imaginary line 92. That is, the pressing portion 89 at the initial position is located between the imaginary line 92 and the recess 229.

In the printer apparatus 1 according to the embodiment, the rear end portion of the cut paper 91 is curved in a high mountain-like shape (an inverted U-shape or an inverted V-shape) having a high center portion between the support portion 221 and the pressing portion 89. In this state, the cut paper 91 is held between the support portion 221 and the pressing portion 89. The rear end of the curved paper 91 is located upstream of the pressing portion 89 in the paper conveying direction.

When new paper is conveyed from the state shown in FIG. 8, a front end of the new paper is located substantially along the imaginary line 92, and thus interferes with two locations of the rear end of the paper 91 curved in a mountain shape. When the new paper interfering with the rear end of the paper 91 is further conveyed, the paper 91 is pushed out downstream in the paper conveying direction and is released from the state of being held by the support portion 221 and the pressing portion 89.

In this way, according to the embodiment, it is possible to provide the printer apparatus 1 that makes it less likely for the cut and discharged paper 91 to fall by using the swing portion 8 which is not a consumable like a brush.

Further, according to the embodiment, when the new paper 91 is discharged without removing the paper 91 held on the support portions 221 and 211, the previous paper 91 can be pushed out by the new paper 91. Therefore, even in a structure in which the paper 91 is held on the support portion 211 and is unlikely to fall, when the new paper 91 is discharged, only the latest paper 91 remains on the support portion 211, and thus the latest paper 91 can be easily determined.

In the embodiment, as shown in FIG. 8, the initial position of the pressing portion 89 is set below the imaginary line 92, but the initial position is not limited thereto in implementation. The discharged paper 91 remains curved according to the diameter of the roll paper 90, and the paper 91 has stiffness according to the thickness or the like. Therefore, even when the initial position of the pressing portion 89 is slightly higher than the imaginary line 92, it is acceptable as long as the pressing portion 89 is configured to press the paper 91 curved above the protrusion 225.

In the embodiment, the swing portion 8 is used as the holding portion, but in implementation, the holding portion may not swing as long as the holding portion does not have the function for jam detection.

The above-described embodiment can be appropriately modified and implemented by changing a part of configurations or functions of each apparatus described above.

Modifications will be described below. In description of the modifications, portions different from those in the above-described embodiment will be mainly described, and portions common to those in the embodiment are denoted by the same reference signs, and detailed description thereof will be omitted.

### First Modification

In implementation, there may be a step or an uneven shape between the shaft 81 and the guide surface 82. That is, a portion between the shaft 81 and the guide surface 82 may not be flat.

For example, it may be difficult to flatten a portion connecting the shaft 81 to the guide surface 82 due to constraints related to a method or a process (as an example, a constraint related to a mold) for manufacturing the swing portion 8, and a step may be provided at this portion. In addition, for example, in order to reduce an influence due to friction with the paper 91, an uneven shape such as a rib may be provided on a surface (including the guide surface 82) of the swing portion 8 to reduce a contact area with the paper 91. There is no intention to exclude these cases in implementation.

With such a configuration, substantially the same effects as those of the configuration in the above-described embodiment can still be achieved.

### Second Modification

Next, the upper surfaces of the support portion 211 and the support portion 221 may not be two surfaces forming an obtuse angle as in FIG. 7, and may form, for example, concave curved surfaces that are adjacent and smoothly continuous. With such a configuration, the same imaginary line 92 is set, the swing portion 8 is disposed at a position where the lower end portion (pressing portion 89) interferes with (intersects) the imaginary line 92, and thus the same effects as those of the configuration in FIG. 7 can still be achieved.

### Third Modification

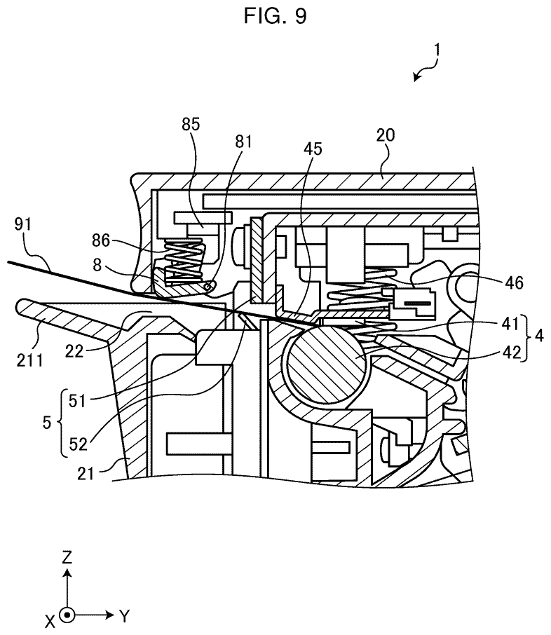

FIG. 9 is an enlarged cross-sectional view of the portion around the paper discharge port 22. The swing portion 8 in this modification includes a biasing member 86 such as a spring. The biasing member 86 biases the swing portion 8 in a direction in which the paper 91 is pressed, and applies a load to pivoting of the swing portion 8 around the shaft 81. This load is for normally operating the swing portion 8 when a paper discharge direction of the printer apparatus 1 is changed from the front to an upward direction. The swing portion 8 is located at the initial position when there is no interference with the paper 91, and receives a load against biasing of the biasing member 86 from the paper 91 as paper is discharged (the paper 91 is discharged).

When an installation orientation assumed for the printer apparatus 1 is fixed, it is possible to design the swing portion 8 to operate by the own weight thereof as in the above-described embodiment. However, the printer apparatus 1 is not limited to the state in which the paper 91 is discharged forward as shown in FIG. 1, and if the printer apparatus 1 can be installed with the paper discharge port 22 facing upward to discharge the paper 91 upward, a design that does not affect the operation of the swing portion 8 even when the orientation of the printer apparatus 1 relative to a vertical direction is changed is required.

As in this modification, by providing the biasing member 86 that provides a biasing force to replace the pressing force in the above-described embodiment, the swing portion 8 can be designed to allow the change in the orientation of the printer apparatus 1 relative to the vertical direction.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A printer apparatus, comprising:
a printing component configured to print while pulling out and conveying strip-shaped paper from wound roll paper with a first surface facing outward;
a cutting component provided downstream of the printing component in a paper conveying direction and configured to cut the strip-shaped paper;
a support component provided downstream of the cutting component in the paper conveying direction and configured to come into contact with a second surface of the strip-shaped paper to support the strip-shaped paper, the support component comprising a pair of recesses located apart from each other in a paper width direction and a protrusion located between the pair of recesses; and
a holding component provided downstream of the cutting component in the paper conveying direction at a position where the holding component faces the pair of recesses and is configured to press the first surface of the strip-shaped paper supported by the support component.

2. The printer apparatus according to claim 1, wherein
a protruding height of each of the protrusions from a periphery thereof at the support component gradually decreases from upstream to downstream in the paper conveying direction.

3. The printer apparatus according to claim 1, wherein
the holding component is located at a position where the holding component interferes with an imaginary line in contact with a tip of the protrusion when the strip-shaped paper does not touch the holding component.

4. The printer apparatus according to claim 1, wherein
the holding component includes a shaft at an end portion on an upstream side in the paper conveying direction, is swingable around the shaft, and presses the strip-shaped paper with a pressing component that is downstream of the shaft in the paper conveying direction.

5. The printer apparatus according to claim 4, wherein
the holding component is biased in a direction in which the pressing component presses the strip-shaped paper.

6. The printer apparatus according to claim 1, wherein
a pressing force of the holding component is larger than a push-up force due to stiffness of the strip-shaped paper.

7. The printer apparatus according to claim 1, wherein
the holding component is further configured to facilitate paper jam detection.

8. A method for a printer, comprising:
printing while pulling out and conveying strip-shaped paper from wound roll paper with a first surface facing outward;
cutting the strip-shaped paper downstream of printing in a paper conveying direction;
downstream of cutting in the paper conveying direction, bringing a support component into contact with a second surface of the strip-shaped paper to support the strip-shaped paper, the support component comprising a pair of recesses located apart from each other in a paper width direction and a protrusion located between the pair of recesses; and
downstream of the cutting in the paper conveying direction at a position where a holding component faces the pair of recesses, and pressing the first surface of the strip-shaped paper supported by the support component using the holding component.

9. The method according to claim 8, wherein
a protruding height of each of the protrusions from a periphery thereof at the support component gradually decreases from upstream to downstream in the paper conveying direction.

10. The method according to claim 8, wherein
the holding component is located at a position where the holding component interferes with an imaginary line in contact with a tip of the protrusion when the strip-shaped paper does not touch the holding component.

11. The method according to claim 8, wherein
the holding component includes a shaft at an end portion on an upstream side in the paper conveying direction, is swingable around the shaft, and presses the strip-shaped paper with a pressing component that is downstream of the shaft in the paper conveying direction.

12. The method according to claim 11, wherein
the holding component is biased in a direction in which the pressing component presses the strip-shaped paper.

13. The method according to claim 8, wherein
a pressing force of the holding component is larger than a push-up force due to stiffness of the strip-shaped paper.

14. A thermal printer, comprising:
a printing component comprising a thermal print head and configured to print while pulling out and conveying strip-shaped paper from wound roll paper with a first surface facing outward;
a cutting component provided downstream of the printing component in a paper conveying direction and configured to cut the strip-shaped paper;
a support component provided downstream of the cutting component in the paper conveying direction and configured to come into contact with a second surface of the strip-shaped paper to support the strip-shaped paper, the support component comprising a pair of recesses located apart from each other in a paper width direction and a protrusion located between the pair of recesses; and
a holding component provided downstream of the cutting component in the paper conveying direction at a position where the holding component faces the pair of recesses and is configured to press the first surface of the strip-shaped paper supported by the support component.

15. The thermal printer according to claim 14, wherein
a protruding height of each of the protrusions from a periphery thereof at the support component gradually decreases from upstream to downstream in the paper conveying direction.

16. The thermal printer according to claim 14, wherein
the holding component is located at a position where the holding component interferes with an imaginary line in contact with a tip of the protrusion when the strip-shaped paper does not touch the holding component.

17. The thermal printer according to claim 14, wherein
the holding component includes a shaft at an end portion on an upstream side in the paper conveying direction, is swingable around the shaft, and presses the strip-shaped paper with a pressing component that is downstream of the shaft in the paper conveying direction.

18. The thermal printer according to claim 17, wherein
the holding component is biased in a direction in which the pressing component presses the strip-shaped paper.

19. The thermal printer according to claim 14, wherein
a pressing force of the holding component is larger than a push-up force due to stiffness of the strip-shaped paper.

20. The thermal printer according to claim 14, wherein
the holding component is further configured to facilitate paper jam detection.
